(19) United States
(12) Patent Application Publication
(10) Pub. No.: US 2013/0136171 A1
(43) Pub. Date: May 30, 2013

(54) Video Signal Encoder/Decoder with 3D Noise Reduction Function and Control Method Thereof

(71) Applicants: I-Hsien Lee, Hsinchu City (TW); Shih-Yuan Peng, New Taipei City (TW); Hong-Long Chou, Taipei City (TW); Chung-Ta Wu, Taichung City (TW); Chia-Ho Pan, Tainan City (TW); Shuei-Lin Chen, Kaohsiung City (TW); Jer-Wei Chang, Hsinchu City (TW)

(72) Inventors: I-Hsien Lee, Hsinchu City (TW); Shih-Yuan Peng, New Taipei City (TW); Hong-Long Chou, Taipei City (TW); Chung-Ta Wu, Taichung City (TW); Chia-Ho Pan, Tainan City (TW); Shuei-Lin Chen, Kaohsiung City (TW); Jer-Wei Chang, Hsinchu City (TW)

(73) Assignee: ALTEK CORPORATION, Hsinchu (TW)

(21) Appl. No.: 13/402,508

(22) Filed: Feb. 22, 2012

(30) Foreign Application Priority Data
Nov. 27, 2011 (TW) 100148727

(51) Int. Cl. H04N 7/34; H04N 7/26

(52) U.S. Cl. 375/240.03; 375/240.16; 375/E07.14; 375/E07.124

(57) ABSTRACT

A video signal encoder/decoder with a 3D noise reduction function and a method thereof. The encoder comprises a storage module, a motion estimation module, a motion compensation module, a first noise reduction module and a coding module. The storage module stores at least one reference image. The motion estimation module receives a first image from an image input end and estimates a motion vector in accordance with the first image and the reference image. The motion compensation module produces motion compensation according to the reference image and the motion vector. The first noise reduction module produces a first noise reduction value with a temporal sequence association according to the first image and the motion compensation. The coding module produces coding data according to the motion compensation and the first noise reduction value.

### CROSS-REFERENCE TO RELATED APPLICATION

This application claims the benefit of Taiwan Patent Application No. 100148727, filed on Dec. 27, 2011, in the Taiwan Intellectual Property Office, the disclosure of which is incorporated herein in its entirety by reference.

### BACKGROUND OF THE INVENTION

1. Field of the Invention

The present invention relates to a video signal processing technology, in particular to a video signal encoder/decoder that integrates video signal compression and 3D noise reduction and saves the hardware cost of an electronic device effectively.

2. Description of the Related Art

In recent years, video signal processing technology has been used extensively in various different electronic products such as digital cameras and digital video cameras, and the video signal processing technology has to process high-resolution images to meet with market requirements. Therefore, more data must be processed and completed within the same time, and increasingly more video signal processing technologies including video signal compression and 3D noise reduction have become necessary functions of the electronic products, and hardware with a higher standard or specification is required. In order to process the high-resolution images, the bandwidth of an image processing chip and an external memory must be increased to meet the requirements for the algorithm of many image frames and the enlarged video signal frames, thus incurring a higher hardware cost such as increasing the bandwidth of the external memory.

With reference to FIG. 1 for a schematic view of a conventional video signal encoder, an image to be encoded or compressed must go through an image processing procedure, and then inputted through an image input end 11 of a H.264 video signal encoder for image compression and encoding. For example, for an inter-frame procedure, it is necessary to input an image that is processed by an image processing such as the 3D noise reduction and perform a motion estimation (ME) 12 with a reference image 14 to generate a motion vector 121, and then perform a motion compensation 13 to generate a compensated image, and this compensated image is subtracted from the inputted image to generate a residual. After the residual is processed through a forward transformation 15 and a quantization 16, an entropy coding 17 generates a compressed code stream and output it to a decoding end.

However, when the aforementioned method is used for performing the image compression and encoding, it is necessary to perform the image processing first. During the image processing, it is necessary to perform the motion estimation, and thus the motion estimation must be perform twice before completing the image processing, compression and encoding. In other words, the image pickup device has to read reference images from the external memory continuously for the motion estimation, and a vast majority of the bandwidth is occupied, so that the resources for other computations are wasted, and the hardware cost is increased. In addition, the motion estimation is performed repeatedly to cause an increase of power consumption and processing. Therefore, it is an issue for related manufacturers as well as a subject of the present invention to lower the hardware cost and the power consumption of the image pickup device, and reduce the time consumed during the image processing, compression and encoding.

### SUMMARY OF THE INVENTION

In view of the aforementioned problems of the prior art, it is a primary objective of the present invention to provide a video signal encoder/decoder with a 3D noise reduction function and a control method thereof in order to improve the performance and the power consumption of electronic devices effectively and reduce the hardware requirements significantly.

To achieve the aforementioned objective, the present invention provides a video signal encoder, comprising: a storage module, for storing at least one reference image; a motion estimation module, coupled to the storage module, for receiving a first image from an image input end, and estimating motion vector according to the at least one reference image and the first image; a motion compensation module, coupled to the storage module and the motion estimation module, for generating a motion compensation according to the at least one reference image and the motion vector; a first noise reduction module, coupled to the motion compensation module, for receiving the first image from the image input end, and generating a first noise reduction value with a temporal sequence association according to the motion compensation and the first image; an encoding module, coupled to the motion compensation module and the first noise reduction module, for generating coding data according to the motion compensation and the first noise reduction value; and an image reconstruction module, for executing a reverse procedure to generate the reference image by using the first noise reduction value.

To achieve the foregoing objective, the present invention further provides a video signal encoding method, applicable for a video signal encoder, comprising the steps of: providing a storage module to store at least one reference image; providing a motion estimation module to receive a first image from an image input end and estimates a motion vector according to the at least one reference image and the first image; using the motion compensation module to generate a motion compensation according to the at least one reference image and the motion vector; using a first noise reduction module to generate a first noise reduction value with a temporal sequence association according to the motion compensation and the first image; generating coding data according to the motion compensation and the first noise reduction value; and executing a reverse process to generate the reference image by using the first noise reduction value.

Preferably, the reference image or the first noise reduction value has a sequence accumulativeness.

Preferably, the first image is an inter-frame.

Preferably, the first noise reduction value is subtracted from the motion compensation to produce a residual.

Preferably, a forward transformation and quantization module is provided for receiving the residual and performing a forward transformation and a quantization of the residual.

Preferably, a second noise reduction module is coupled to the storage module for receiving a second image from the image input end, and the second noise reduction module generates a second noise reduction value with a temporal sequence association according to the at least one reference image and the second image.

Preferably, the second image is an intra-frame.

To achieve the foregoing objective, the present invention further provides a video signal encoder, comprising: a storage means for storing at least one reference image; a motion estimation means for receiving a first image from an image input end, and estimating a motion vector according to the at least one reference image and the first image; a motion compensation means for generating a motion compensation according to the at least one reference image and the motion vector; a first noise reduction means for receiving the first image from the image input end, and generating a first noise reduction value with a temporal sequence association according to the motion compensation and the first image; an encoding module means for generating a coding data according to the motion compensation and the first noise reduction value; and an image reconstruction means for executing a reverse procedure to generate the reference image by using the first noise reduction value.

Preferably, the present invention further comprises a forward transformation and quantization means for receiving the residual, and performing a forward transformation and a quantization of the residual.

Preferably, the present invention further comprises a second noise reduction means for receiving a second image from the image input end, and generating a second noise reduction value with the temporal sequence association according to the at least one reference image and the second image.

In summation, the video signal encoder/decoder with a 3D noise reduction function and the control method thereof in accordance with the present invention have one or more of the following advantages:

(1) The video signal encoder/decoder with a 3D noise reduction function and the control method need not to execute a motion estimation for the image processing and image compression, and thus the computation and the bandwidth for accessing data from the memory can be reduced to save the hardware cost significantly.

(2) The video signal encoder/decoder with a 3D noise reduction function and the control method combine the image processing, compression and encoding together, and thus is the time required for the electronic device to execute the image processing, compression and encoding can be reduced to improve the performance and reduce the power consumption.

### BRIEF DESCRIPTION OF THE DRAWINGS

FIG. 1 is a schematic view of a conventional video signal encoder;

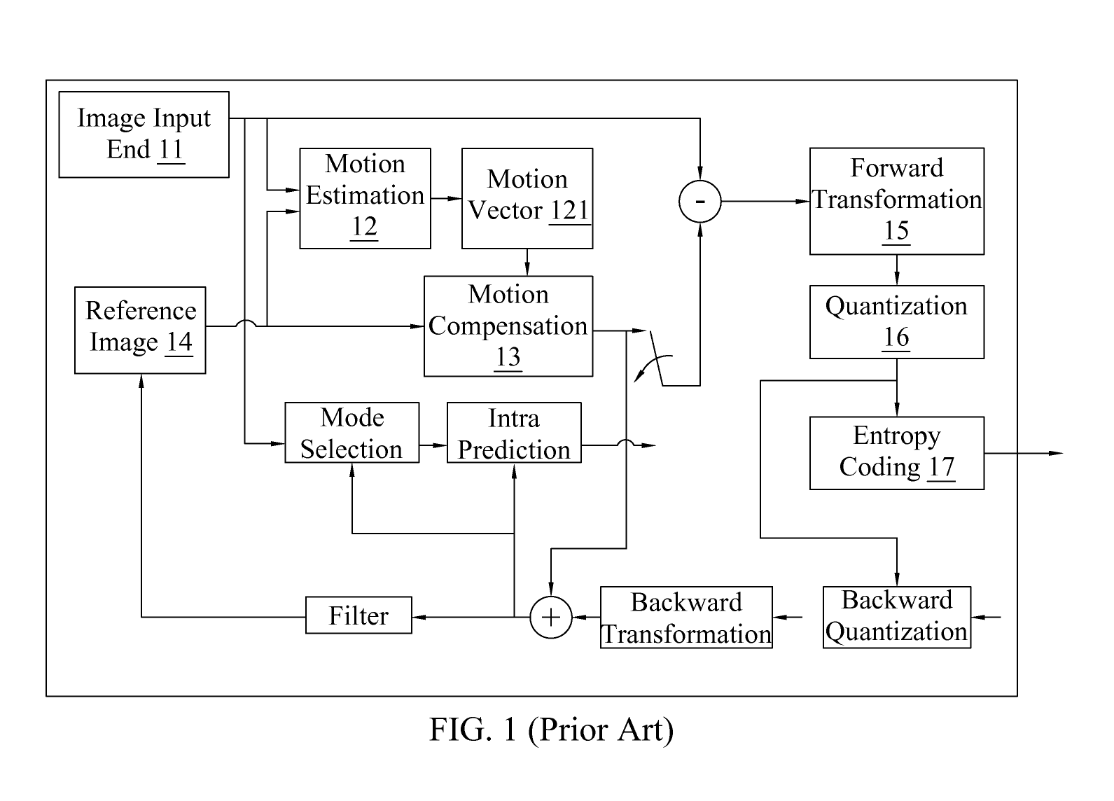

FIG. 2 is a block diagram of a video signal encoder in accordance with a first preferred embodiment of the present invention;

FIG. 3 is a schematic view of a video signal encoder in accordance with the first preferred embodiment of the present invention;

FIG. 4 is a flow chart of a video signal encoder in accordance with the first preferred embodiment of the present invention;

FIG. 5 is a block diagram of a video signal encoder in accordance with a second preferred embodiment of the present invention;

FIG. 6 is a schematic view of a video signal encoder in accordance with the second preferred embodiment of the present invention;

FIG. 7 is a flow chart of a video signal encoder in accordance with the second preferred embodiment of the present invention;

FIG. 8 is a block diagram of a video signal decoder in accordance with the first preferred embodiment of the present invention;

FIG. 9 is a schematic view of a video signal decoder in accordance with the first preferred embodiment of the present invention; and

FIG. 10 is a flow chart of a video signal encoding method of the present invention.

### DESCRIPTION OF THE PREFERRED EMBODIMENTS

The technical characteristics of the present invention will become apparent with the detailed description of the preferred embodiments accompanied with the illustration of related drawings as follows. It is noteworthy to point out that the drawings are provided for the purpose of illustrating the present invention, but they are not necessarily drawn according to the actual scale, or are intended for limiting the scope of the invention.

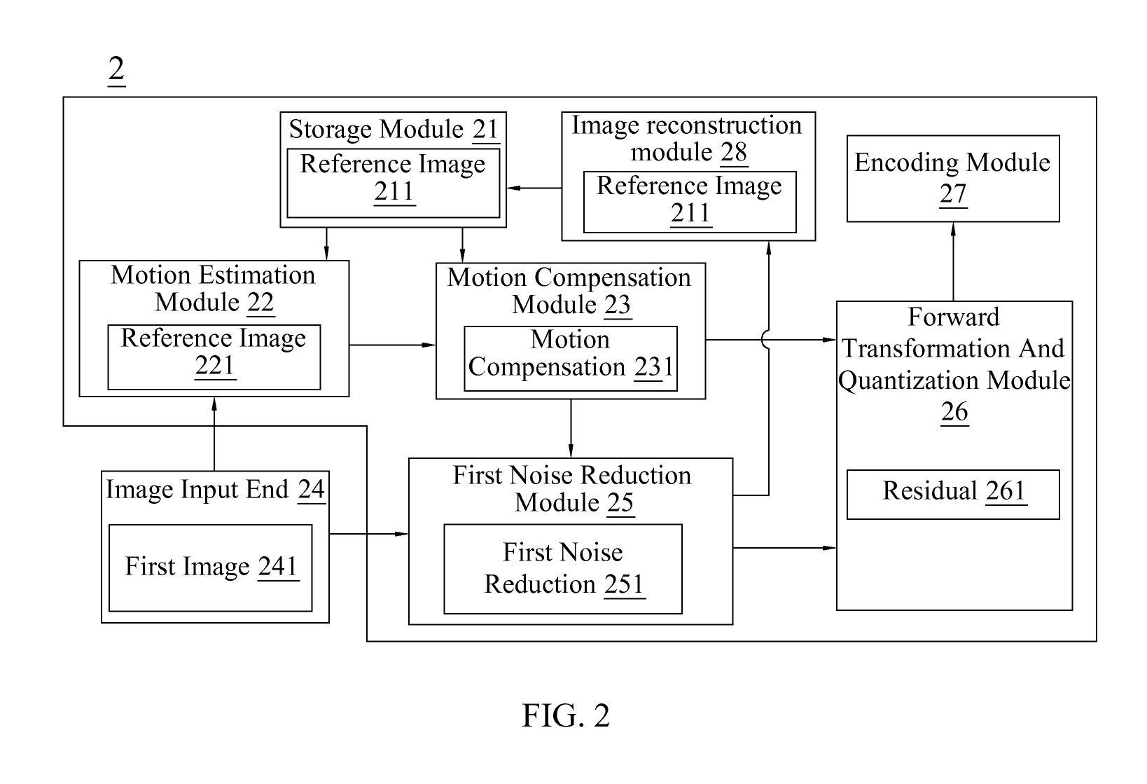

With reference to FIG. 2 for a block diagram of a video signal encoder in accordance with a first preferred embodiment of the present invention, the video signal encoder 2 comprises a storage module 21, a motion estimation module 22, a motion compensation module 23, a first noise reduction module 25, a forward transformation and quantization module 26, an encoding module 27 and an image reconstruction module 28.

The storage module 21 has at least one reference image 211 saved therein and used as a basis for the video signal processing. The motion estimation module 22 is coupled to the storage module for receiving a first image 241 from the image input end 24 and receiving a reference image 211 saved in the storage module 21 to perform a motion estimation (ME) and generate a motion vector 221.

The motion compensation module 23 is coupled to the storage module 21 and the motion estimation module 22 for performing a motion compensation (MC) to generate a motion compensation 231 according to the reference image 211 and the motion vector 221. The first noise reduction module 25 is coupled to the motion compensation module 23 for performing an image processing such as a 3D noise reduction to generate a first noise reduction value 251 with a temporal sequence association according to the first image 241 and the motion compensation 231, wherein the first image is an inter-frame. The first noise reduction value 251 will reduce the noises continuously with the increased number of executions, so that a sequence accumulativeness can be achieved.

The forward transformation and quantization module 26 is electrically coupled to the first noise reduction module 25 and the motion compensation module 23. The aforementioned first noise reduction value 251 is subtracted from the motion compensation 231 by a subtractor (not shown in the figure) to generate a residual 261, and a forward transformation and a quantization of the residual 261 are performed by the forward transformation and quantization module 26. The encoding module 27 is electrically coupled to forward transformation and quantization module 26, and after the forward transformation and the quantization of the residual 261 are performed, the result is transmitted to the encoding module for encoding to generate coding data 271. Of course, the video signal encoder 2 also includes an intra prediction module (not shown in the figure) for processing the intra-frame.

The image reconstruction module 28 executes a reverse procedure to generate a reference image 211 by the first noise reduction value 251 and uses the reference image 211 for the encoding later, and the noise reduction effect of this time is accumulated to the later encoding procedure.

It is noteworthy to point out that the selection of motion vector in the prior art gives a minimum compression after the difference between the image block processed by the motion compensation and the image block to be compressed is processed by the forward transformation, the quantization and the entropy coding. Therefore, its purpose is to pursue the most effective data storage and transmission. In the prior art, the main consideration is to achieve the effect of loyally recording the original inputted image by using the minimum bit rate. However, this method has not taken the image quality and the effect of noises on the compression efficiency into consideration. In the image compression process, each block will be converted to a frequency area which is a high frequency portion of the noise, so that a relatively large bit rate is consumed, and the compression efficiency is lowered. In addition, the way of using a noise image for the most loyal compression is definitely not the best method.

Therefore, the present invention removes the limitation of inputting the result of the image processing to the video signal encoder, and combines the video signal compression and the image processing together for directly inputting the image with the noise into the video signal encoder. The advantage of this method is that the first noise reduction module 25 can be calculated by the motion estimation module 22 directly to obtain the motion vector 221 without the need of calculating the motion vector required by the image processing, so that the number of times of repeatedly reading the reference image 211 from the storage module 21 by the image pickup device can be reduced, and the hardware requirement of the image pickup device can be reduced significantly. Unlike the prior art, the motion estimation module 22 performs the motion estimation by using the first image 241 with a noise and the reference image 211. However, the residual 261 is obtained by performing an image processing to calculate the first noise reduction value 251 and the motion compensation 231.

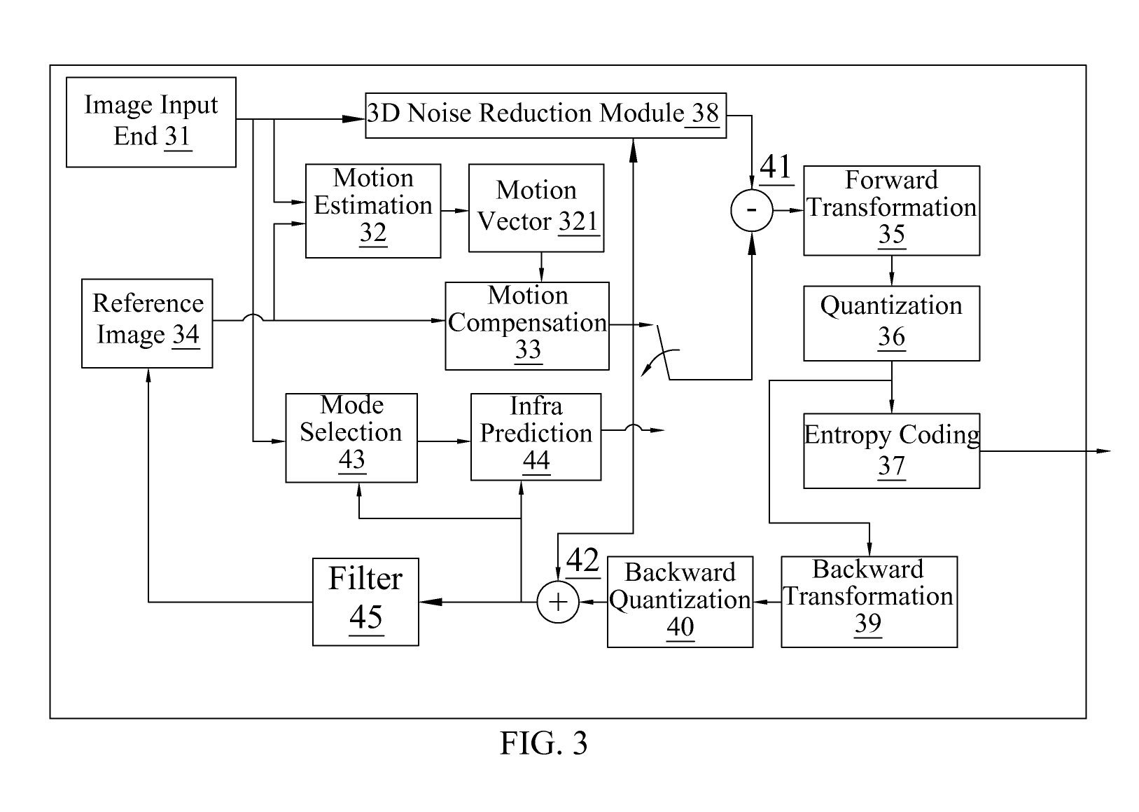

With reference to FIG. 3 for a schematic view of a video signal encoder in accordance with the first preferred embodiment of the present invention, an image to be processed is inputted from an image input end 31 of the video signal encoder, and similarly the image to be processed is an image without being processed by the 3D noise reduction process. Now, the video signal encoder will retrieve a reference image 34 from an external memory (not shown in the figure) and perform a motion estimation 32 to generate a motion vector 321 according to the reference image 34 and the image to be processed, and the motion vector 321 is used for performing a motion compensation 33 of the reference image 34 to generate a compensated image. Now, the 3D noise reduction module 38 performs a 3D noise reduction to generate a processed image according to the image with a noise to be processed and the compensated image.

In other words, the video signal encoder of the present invention simply needs to perform the motion estimation once to achieve the effects of both 3D noise reduction and image compression, so as to reduce the hardware requirement of the electronic device, improve the performance, and lower the power consumption effectively. Therefore, the present invention is applicable for digital cameras, digital video cameras, camera phones, or any other electronic device that requires image processing, compression and encoding.

After the processed image and the compensated image are subtracted by the subtractor 41, a residual is obtained, and after a forward transformation 35 and a quantization 36 of the residual are performed, and the entropy coding 37 will generate a compressed code stream. Of course, besides the residual, the compressed code stream further includes other parameters such as the motion vector. To provide the reference image 34, the video signal encoder requires a function of rebuilding the image, so that after the forward transformation 35 and the quantization 36 of the residual are performed, a backward quantization 39 and a backward transformation 40 are required to reduce the residual, and an adder 42 is provided for adding the compensated image, and a de-blocking filter 45 is provided for processing to reduce the processed image as the reference image 34. The noise reduction effect can be accumulated for a later encoding procedure. Wherein, the purpose of installing the de-blocking filter 45 under the H.264 standard is to provide a smoother image. Similarly, the reference image 34 also has the sequence accumulativeness.

It is noteworthy to point out that when the conventional video signal encoder executes the image processing, the motion estimation can be done by various different ways according to the requirements of the image processing. For example, a motion estimation of a moving object in a frame can be performed or a motion estimation of the whole frame can be performed, and the aforementioned two motion estimations have different standards of determining the motion vector. To combine the 3D noise reduction, image compression and image encoding, the video signal encoder of the present invention sacrifices the flexibility of the motion estimation to reduce the hardware cost and the power consumption of the electronic device as well as the time required for the image processing, compression and encoding. In other words, the video signal encoder of the present invention no longer uses the encoding efficiency as the standard of determining the motion vector but uses the minimum difference between the blocks as the standard of determining the motion vector.

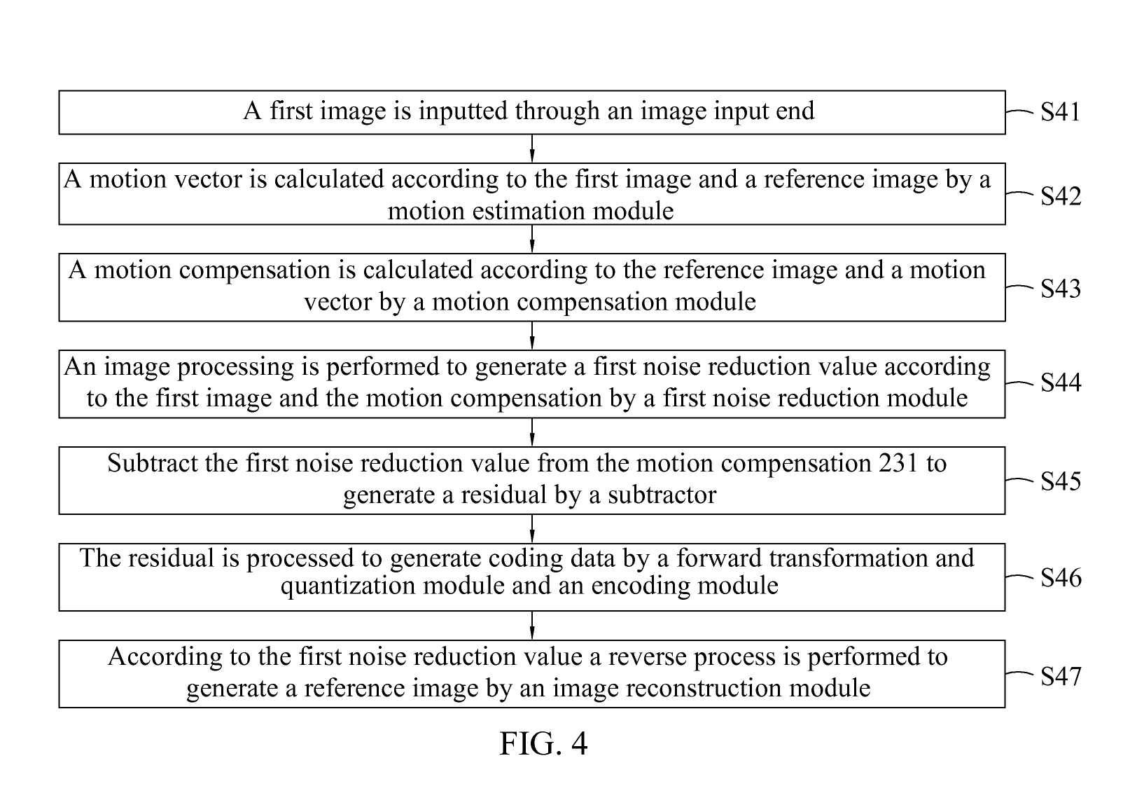

With reference to FIG. 4 for a flow chart of a video signal encoder in accordance with the first preferred embodiment of the present invention, the video signal encoder performs the following steps.

In step S41, a first image is inputted through an image input end.

In step S42, a motion vector is calculated according to the first image and a reference image by a motion estimation module.

In step S43, a motion compensation is calculated according to the reference image and a motion vector by a motion compensation module.

In step S44. an image processing is performed to generate a first noise reduction value according to the first image and the motion compensation by a first noise reduction module.

In step S45, Subtract the first noise is subtracted the first noise reduction value from the motion compensation to generate a residual by a subtractor.

In step S46, the residual is processed to generate coding data by a forward transformation and quantization module and an encoding module.

In step S47, according to the first noise reduction value a reverse process is performed to generate a reference image by an image reconstruction module.

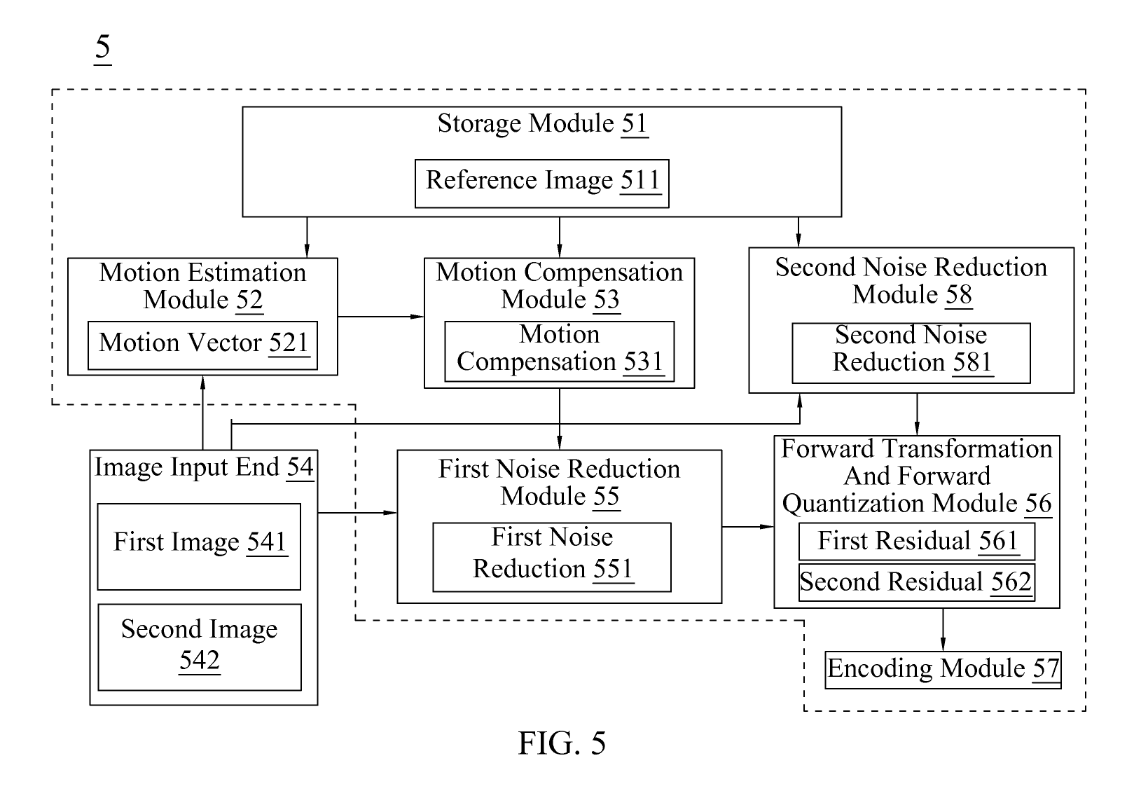

With reference to FIG. 5 for a block diagram of a video signal encoder in accordance with the second preferred embodiment of the present invention, the processing of compressing the P-frame by the video signal encoder 5 of this preferred embodiment is the same as the first preferred embodiment. The motion estimation module 52 generates a motion vector 521 according to the reference image 511 retrieved from the storage module 51 and the first image 541 inputted from the image input end 54, and the motion compensation module 53 generates a motion compensation 531 according to the reference image 511 and the motion vector 521. The first noise reduction module 55 eliminates the noise of the first image 541 according to the motion compensation 531 to generate a first noise reduction value 551. The first noise reduction value 551 is subtracted from the motion compensation 531 to generate a residual 561, and after a forward transformation and a quantization module 56, the result is transmitted to the encoding module 57 for encoding.

As to the compression of the I-frame, the difference between this preferred embodiment and the first preferred embodiment is that this preferred embodiment adds a second noise reduction module 58 which is electrically coupled to the storage module 51 and the forward transformation and quantization module 56. It is noteworthy to point out that this second noise reduction module 58 will execute an image processing to generate a second noise reduction value 581 according to the reference image 511 and the second image 542. Wherein, the second image is an intra-frame. Of course, the video signal encoder 5 also includes an intra prediction module (not shown in the figure) for performing a mode selection and an intra prediction of the second noise reduction value 581 to generate an intra prediction and subtracting the second noise reduction value 581 from the intra prediction to obtain a residual 562, and after the residual 562 is processed by the transformation and quantization module 56, the result is transmitted to the encoding module 57 for encoding.

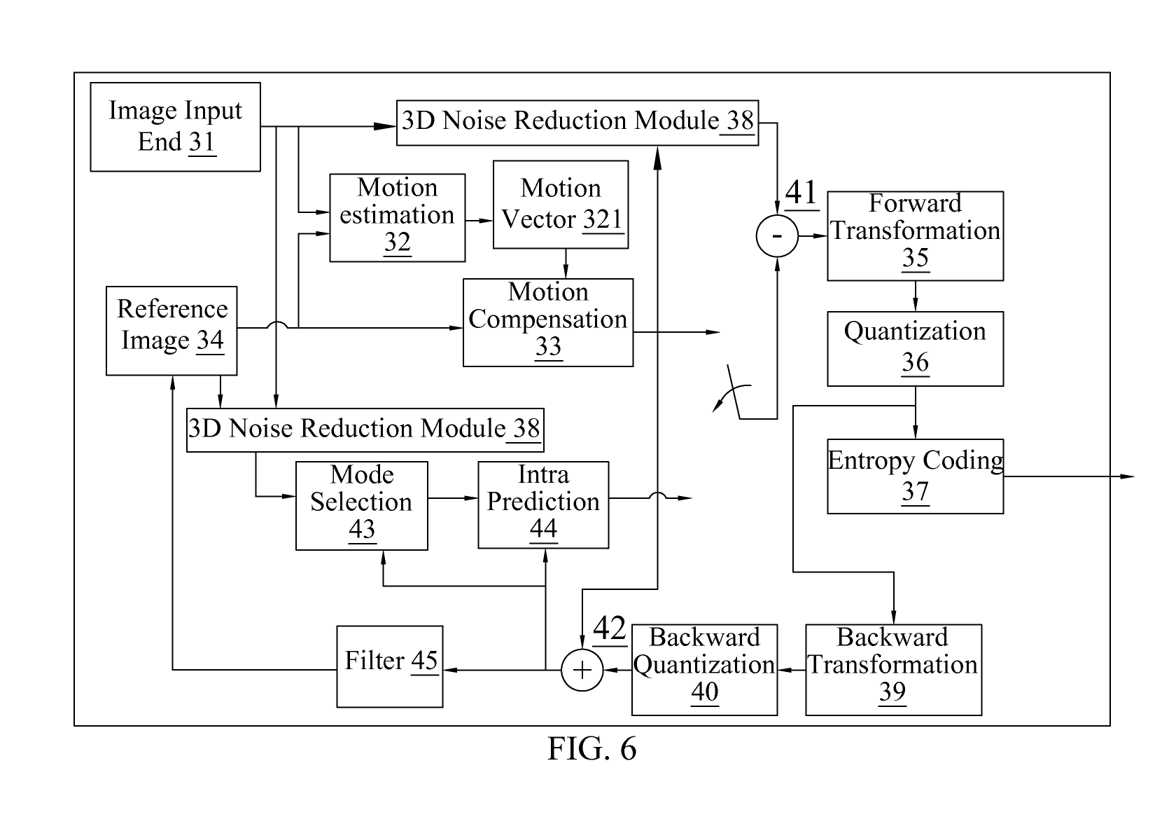

With reference to FIG. 6 for a schematic view of a video signal encoder in accordance with the second preferred embodiment of the present invention, the processing of compressing the P-frame by the video signal encoder of this preferred embodiment is the same as the first preferred embodiment, and thus will not be described again. In the procedure of compressing the I-frame, the 3D noise reduction module 46 will according to the reference image 34 retrieved from the external memory (not shown in the figure) and an image with a noise to be executed by the 3D noise reduction and inputted from the image input end 31 to generate a processed image. An mode selection 43 and an intra prediction 44 of the processed image are performed to generate a result, which is subtracted from the processed image to generate a residual, and a forward transformation 35, a quantization 36 and an entropy coding 37 of the residual are performed to generate a compressed code stream to be entered into a decoding end. Of course, besides the residual, the compressed code stream further includes a frame prediction mode quantization parameter. Similarly, after a forward transformation 35 and a quantization 36 of the residual are performed, reverse procedures including a backward quantization 39 and a backward transformation 40 of the processed image are preformed to generate a reference image 34.

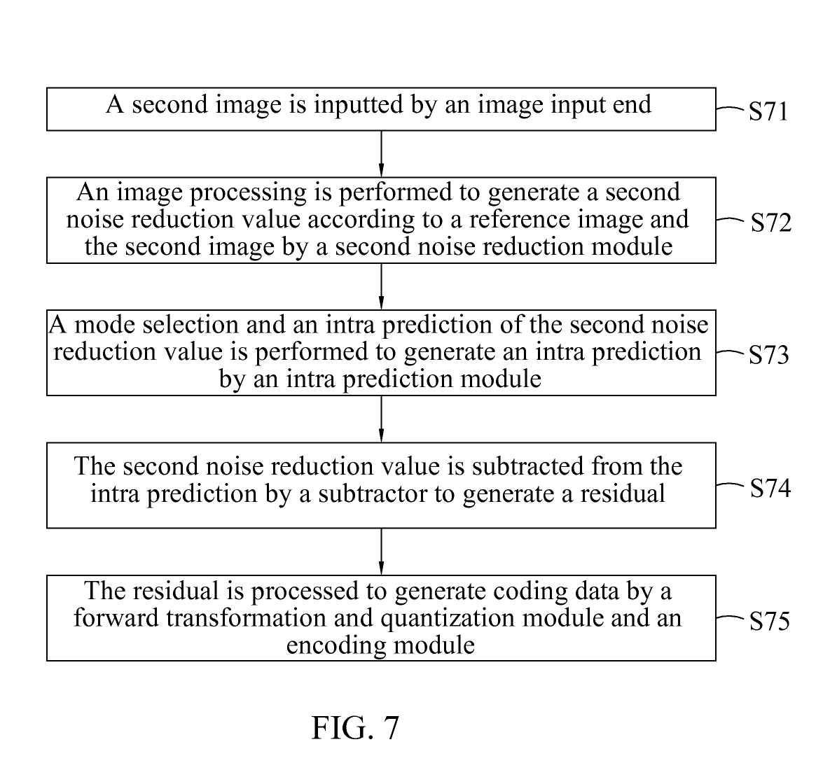

With reference to FIG. 7 for a flow chart of a video signal encoder in accordance with the second preferred embodiment of the present invention, the processing of the P-frame in this preferred embodiment is the same as the first preferred embodiment, and thus will not be described again.

In step S71, a second image is inputted by an image input end.

In step S72, an image processing is performed to generate a second noise reduction value according to a reference image and the second image by a second noise reduction module.

In step S73, a mode selection and an intra prediction of the second noise reduction value is performed to generate an intra prediction by an intra prediction module.

In step S74, the second noise reduction value is subtracted from the intra prediction by a subtractor to generate a residual.

In step S75, the residual is processed to generate coding data by a forward transformation and quantization module and an encoding module.

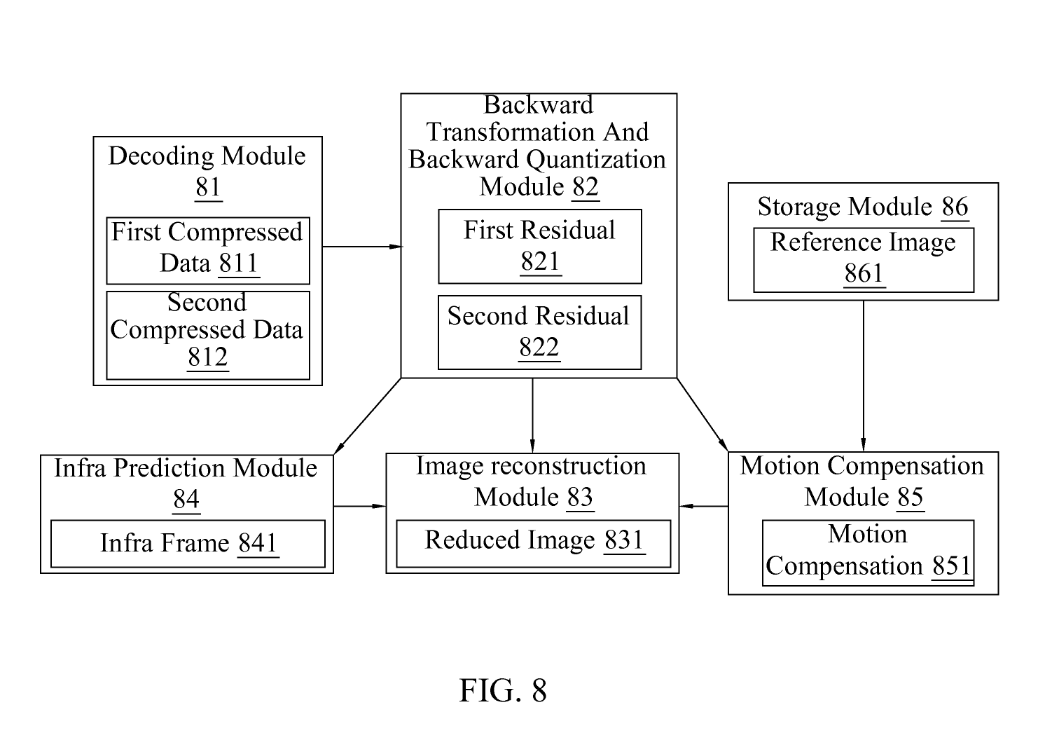

With reference to FIG. 8 for a block diagram of a video signal decoder in accordance with the first preferred embodiment of the present invention, the video signal decoder comprises a decoding module 81, a backward transformation and backward quantization module 82, an image reconstruction module 83, an intra prediction module 84, a motion compensation module 85 and a storage module 86.

To decode and reduce the image of P-Frame, the decoding module 81 will decode the coding data transmitted from the encoding end into first compressed data 811. The backward transformation and backward quantization module 82 is electrically coupled to the decoding module 81, and a backward transformation and a backward quantization of the first compressed data 811 are processed by the backward transformation and backward quantization module 82 to generate a first residual 821. The motion compensation module 85 is electrically coupled to the storage module 86 and the backward transformation and backward quantization module 82, and a motion compensation 851 is generated according to a parameter such as a motion vector included in the coding data and a reference image 861 retrieved from the storage module. The image reconstruction module is electrically coupled to the backward transformation and backward quantization module 82, the intra prediction module 84 and the motion compensation module 85 for generating a reduced image 831 according to the motion compensation 851 and the first residual 821.

Similarly, to decode and reduce the image of I-Frame, the decoding module 81 will decode the coding data transmitted form the encoding end into a second compressed data 812, Wherein, the coding data also include a frame prediction mode quantization parameter, and a backward transformation and a backward quantization of the second compressed data 812 are processed by the backward transformation and backward quantization module 82 to generate a second residual 822. Now, the intra prediction module 84 executes an intra prediction to generate an inter-frame 841. Therefore, the image reconstruction module 83 can combine the aforementioned information to generate a reduced image 831.

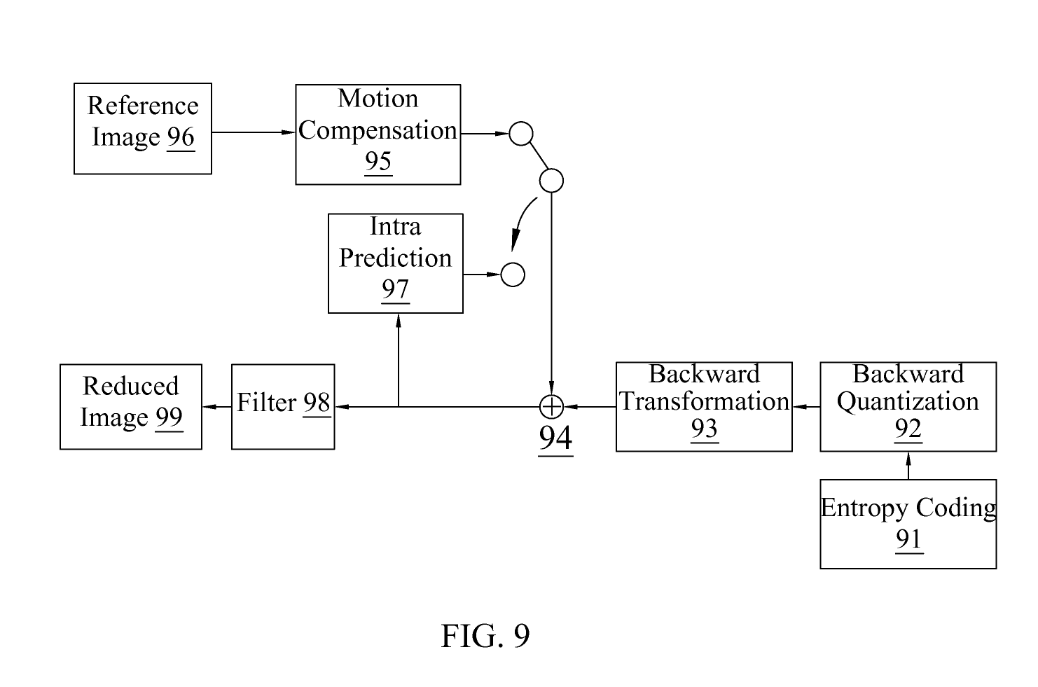

With reference to FIG. 9 for a schematic view of a video signal decoder in accordance with the first preferred embodiment of the present invention, to reduce the image of P-frame, a compressed code stream transmitted from an encoding end and processed by an entropy code 91 generates a forward transformation coefficient after the quantization takes place, and obtains a residual after the backward quantization 92 and the backward transformation 93 take place. Now, the video signal decoder obtains a motion vector and a reference image 96 by decoding to execute a motion compensation 95, and the generated result is added to the residual by an adder 94, and finally processed by a filter 98 to obtain the reduced image 99. Similarly, to reduce the image of I-Frame, the video signal decoder obtains the reduced image 99 through an intra prediction 97.

Although the concept of the video signal encoding method of the present invention has been described in the section of the video signal encoder of the present invention, the following flow chart is provided to illustrate the invention more clearly.

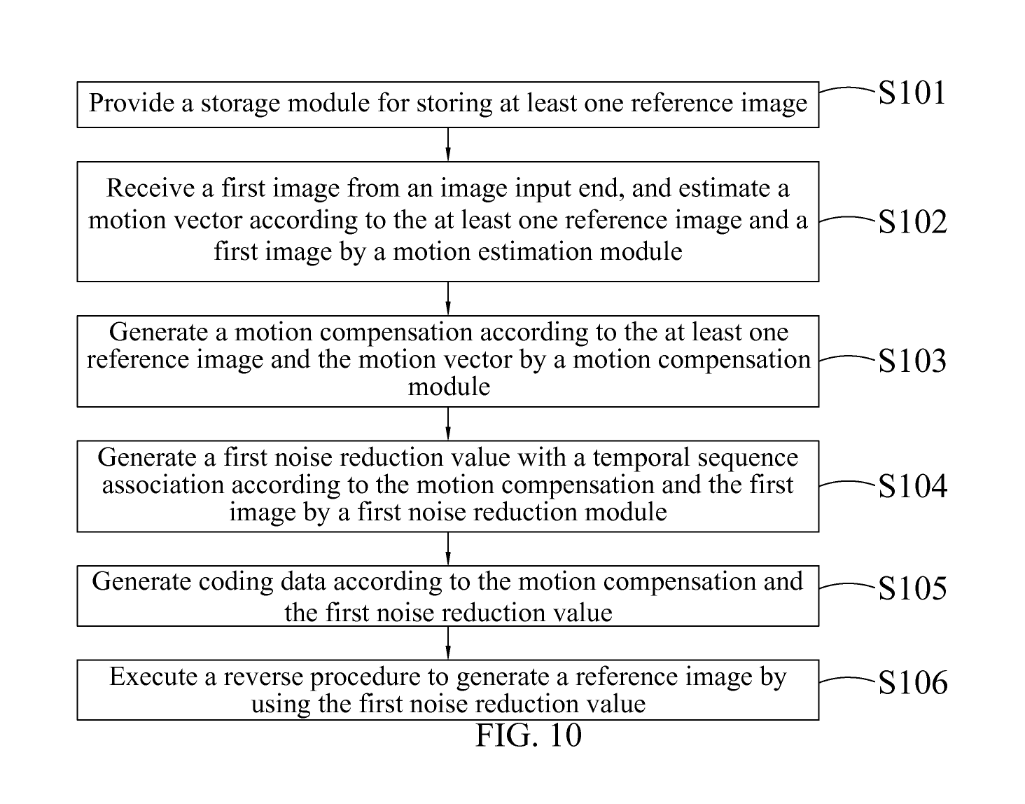

With reference to FIG. 10 for a flow chart of a video signal encoding method of the present invention, the video signal encoding method is applicable for a video signal encoder, and the video signal encoder comprises a storage module, a motion estimation module, a motion compensation module and a first noise reduction module. The video signal encoding method comprises the following steps:

S101: Provide a storage module for storing at least one reference image.

S102: Receive a first image from an image input end, and estimate a motion vector according to the at least one reference image and a first image by a motion estimation module.

S103: Generate a motion compensation according to the at least one reference image and the motion vector by a motion compensation module.

S104: Generate a first noise reduction value with a temporal sequence association according to the motion compensation and the first image by a first noise reduction module.

S105: Generate coding data according to the motion compensation and the first noise reduction value.

S106: Execute a reverse procedure to generate a reference image by using the first noise reduction value.

In summation of the description above, the video signal encoder/decoder with a 3D noise reduction function and the control method thereof in accordance with the present invention need not to execute an motion estimation for the image processing and image compression, and thus reducing the number of times of reading data from the external memory repeatedly, the computation volume and the bandwidth of accessing data from the memory, so as to save the hardware requirements and the manufacturing cost significantly. In addition, the video signal encoder/decoder with a 3D noise reduction function and the control method thereof in accordance with the present invention combine the image processing, compression and encoding together to reduce the time required for the electronic device to execute the image processing, compression and encoding, so as to achieve the effects of expediting the processing speed, improving the performance and reducing the power consumption. Therefore, the present invention can overcome the drawbacks of the prior art.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A video signal encoder, comprising:
a storage module, arranged for storing at least one reference image;
a motion estimation module, coupled to the storage module, arranged for receiving a first image from an image input end, and estimating a motion vector according to the at least one reference image and the first image;
a motion compensation module, coupled to the storage module and the motion estimation module, arranged for generating a motion compensation according to the at least one reference image and the motion vector;
a first noise reduction module, coupled to the motion compensation module, arranged for receiving the first image from the image input end, and generating a first noise reduction value with a temporal sequence association according to the motion compensation and the first image;
an encoding module, coupled to the motion compensation module and the first noise reduction module, arranged for generating a coding data according to the motion compensation and the first noise reduction value; and
an image reconstruction module, arranged for executing a reverse procedure to generate the reference image by using the first noise reduction value.

2. The video signal encoder of claim 1, wherein the at least one reference image or the first noise reduction value has a sequence accumulativeness.

3. The video signal encoder of claim 1, wherein the first image is an inter-frame.

4. The video signal encoder of claim 1, wherein the first noise reduction value is subtracted from the motion compensation to generate a residual.

5. The video signal encoder of claim 4, further comprising a forward transformation and quantization module for receiving the residual, and performing a forward transformation and a quantization of the residual.

6. The video signal encoder of claim 1, further comprising a second noise reduction module coupled to the storage module, wherein the second noise reduction module receives a second image from the image input end, and generating a second noise reduction value with the temporal sequence association according to the at least one reference image and the second image.

7. The video signal encoder of claim 6, wherein the second image is an intra-frame.

8. A video signal encoding method, applicable for a video signal encoder, comprising the steps of:
providing a storage module to store at least one reference image;
providing a motion estimation module to receive a first image from an image input end and estimates a motion vector according to the at least one reference image and the first image;
using the motion compensation module to generate a motion compensation according to the at least one reference image and the motion vector;
using a first noise reduction module to generating a first noise reduction value with a temporal sequence association according to the motion compensation and the first image;
generating a coding data according to the motion compensation and the first noise reduction value; and
executing a reverse process to generate the reference image by using the first noise reduction value.

9. The video signal encoding method of claim 8, wherein the at least one reference image or the first noise reduction value has a sequence accumulativeness.

10. The video signal encoding method of claim 8, wherein the first image is an inter-frame.

11. The video signal encoding method of claim 8, further comprising a step of subtracting the first noise reduction value from the motion compensation to generate a residual.

12. The video signal encoding method of claim 11, further comprising a step of: using a forward transformation and quantization module to receive the residual, and perform a forward transformation and a quantization of the residual.

13. The video signal encoding method of claim 8, further comprising the steps of: using a second noise reduction module for receiving a second image from the image input end; and generating a second noise reduction value with the temporal sequence association according to the at least one reference image and the second image.

14. The video signal encoding method of claim 13, wherein the second image is an intra-frame.

15. A video signal encoder, comprising:
a storage means for storing at least one reference image;
a motion estimation means for receiving a first image from an image input end, and estimating a motion vector according to the at least one reference image and the first image;
a motion compensation means for generating a motion compensation according to the at least one reference image and the motion vector;
a first noise reduction means for receiving the first image from the image input end, and generating a first noise reduction value with a temporal sequence association according to the motion compensation and the first image;
an encoding means for generating a coding data according to the motion compensation and the first noise reduction value; and
an image reconstruction means for executing a reverse procedure to generate the reference image by using the first noise reduction value.

16. The video signal encoder of claim 15, further comprising a forward transformation and quantization means for receiving the residual, and performing a forward transformation and a quantization of the residual.

17. The video signal encoder of claim 15, further comprising a second noise reduction means for receiving a second image from the image input end, and generating a second noise reduction value with the temporal sequence association according to the at least one reference image and the second image.
